(19) United States
(12) Patent Application Publication
(10) Pub. No.: US 2022/0156517 A1
(43) Pub. Date: May 19, 2022

(54) Method for Generating Training Data for a Recognition Model for Recognizing Objects in Sensor Data from a Surroundings Sensor System of a Vehicle, Method for Generating a Recognition Model of this kind, and Method for Controlling an Actuator System of a Vehicle

(71) Applicant: Robert Bosch GmbH, Stuttgart (DE)

(72) Inventors: Christian Haase-Schuetz, Fellbach (DE); Heinz Hertlein, Erlenbach (DE); Joscha Liedtke, Besigheim (DE)

(21) Appl. No.: 17/529,737

(22) Filed: Nov. 18, 2021

(30) Foreign Application Priority Data
Nov. 19, 2020 (DE) 10 2020 214 596.2

(51) Int. Cl. G06K 9/62; G06K 9/00; B60W 50/00; G06N 20/00

(52) U.S. Cl. CPC G06K 9/6256; G06K 9/00791; G06K 9/00979; B60W 50/00; G06N 20/00; B60W 2050/0028; B60W 2710/06; B60W 2710/08; B60W 2710/18; B60W 2710/20; B60W 2050/0085

(57) ABSTRACT

The present disclosure relates to a method for generating training data for a recognition model for recognizing objects in sensor data of a vehicle. First sensor data and second sensor data are input into a learning algorithm. The first sensor data comprise measurements of a first surroundings sensor. The second sensor data comprise a measurements of a second surroundings sensor. A training data generation model is generated, using learning algorithm, that generates measurements of the second surroundings sensor assigned to measurements of the first surroundings sensor. First simulation data are input into the training data generation model. The first simulation data comprise simulated measurements of the first surroundings sensor. Second simulation data are generated as the training data based on the first simulation data using the training data generation model. The second simulation data comprise simulated measurements of the second surroundings sensor.

This application claims priority under 35 U.S.C. § 119 to application no. DE 10 2020 214 596.2, filed on Nov. 19, 2020 in Germany, the disclosure of which is incorporated herein by reference in its entirety.

### TECHNICAL FIELD

The disclosure relates to a method for generating training data for a recognition model for recognizing objects in sensor data from a surroundings sensor system of a vehicle, a method for generating a recognition model for recognizing objects in sensor data from a surroundings sensor system of a vehicle, and a method for controlling an actuator system of a vehicle. The disclosure also relates to an apparatus, a computer program and a computer-readable medium for carrying out at least one of the aforementioned methods.

### BACKGROUND

An important aspect in the development, optimization and testing of autonomous or semiautonomous driving and assistance functions is the large number of possible conditions to be taken into account. This involves taking into account, as far as possible, all the relevant conditions in the training of algorithms for producing such systems.

Moreover, adequate performance of the system under all conditions, and thus the safety of the system, should be ensured by performing testing of the algorithms and functions for possible situations. The conditions to be taken into account may, for example, be different states of the surroundings, for example due to weather conditions or changes in lighting, which influence the measurement data depending on the respective sensor modality, different traffic situations or varying behaviors by other road users. In particular in the case of semiautonomous functions, different driving situations and driving styles of the ego vehicle are also to be taken into account. Suitable road tests or simulations can be performed for this purpose.

Use can be made, for example, of machine learning algorithms, e.g. in the form of artificial neural networks, to process sensor data and/or to recognize objects. In order to train algorithms of this kind, it is generally necessary to annotate an initially unlabeled sample, i.e. to determine ground truth parameters of relevant static and/or dynamic objects in the surroundings of the ego vehicle. This can be achieved, for example, by manually assigning labels, which can be very time-consuming and costly due to the large amounts of data.

### SUMMARY

Against this background, the approach presented here presents a method for generating training data, a method for generating a recognition model, a method for controlling an actuator system of a vehicle, an apparatus, a computer program and a computer-readable medium according to the disclosure. Advantageous developments and improvements of the approach presented here emerge from the description and are described in the embodiments.

### Advantages of the Disclosure

Embodiments of the present disclosure advantageously make it possible to generate labeled training data for the machine learning of a surroundings recognition model, e.g. in connection with a vehicle driving in automated fashion or an autonomous robot, without manually assigning labels. This makes it possible to significantly reduce the outlay in terms of time and money for the realization, optimization and/or evaluation of autonomous driving functions.

For example, in road tests, either functions of a (semi)autonomous vehicle that are to be tested can be assessed directly in the vehicle, or sensor data and, if necessary, relevant system states can be recorded. The recorded data can be referred to as a sample. Algorithms and functions can then be evaluated using this sample.

Another option for obtaining labeled data is to perform simulations. In this case, suitable generation models can be used to generate synthetic sensor data. The result of a simulation of this kind may, once again, be a sample, wherein, in this case, the ground truth parameters or labels are directly available, with the result that laborious manual labeling can be dispensed with.

In practice, however, simulations of this kind often have only limited use, since it is generally impossible to produce sufficiently accurate generation models for all sensor modalities and the interaction thereof with the surroundings. For example, due to the complex physical relationships, it is a considerable challenge to generate realistic radar sensor measurement data.

The approach described below makes it possible to provide, with a relatively low degree of computational effort, synthetic sensor data of sufficient quality for sensor modalities that are difficult to simulate or can be simulated only with a very high level of outlay, such as radar sensors.

A first aspect of the disclosure relates to a computer-implemented method for generating training data for a recognition model for recognizing objects in sensor data from a surroundings sensor system of a vehicle. The method comprises at least the following steps: inputting first sensor data and second sensor data into a learning algorithm, wherein the first sensor data comprise a plurality of chronologically successive real measurements of a first surroundings sensor of the surroundings sensor system, the second sensor data comprise a plurality of chronologically successive real measurements of a second surroundings sensor of the surroundings sensor system, and a temporally corresponding real measurement of the second surroundings sensor is assigned to each of the real measurements of the first surroundings sensor; generating a training data generation model, which generates measurements of the second surroundings sensor assigned to measurements of the first surroundings sensor, based on the first sensor data and the second sensor data by means of the learning algorithm;

inputting first simulation data into the training data generation model, wherein the first simulation data comprise a plurality of chronologically successive simulated measurements of the first surroundings sensor; and generating second simulation data as the training data based on the first simulation data by means of the training data generation model, wherein the second simulation data comprise a plurality of chronologically successive simulated measurements of the second surroundings sensor.

The method may, for example, be carried out automatically by a processor.

A vehicle may be a motor vehicle, e.g. in the form of an automobile, a truck, a bus or a motorcycle. In the broader sense, a vehicle can also be understood to mean an autonomous mobile robot.

The first surroundings sensor and the second surroundings sensor may differ from one another in terms of sensor type. In other words, the two surroundings sensors may constitute different sensor modalities or sensor instances. In particular, the second surroundings sensor may be a surroundings sensor whose measurements are not as easy to simulate as measurements of the first surroundings sensor. For example, the first surroundings sensor may be a lidar sensor or a camera, while the second surroundings sensor may, for example, be a radar sensor or an ultrasonic sensor.

The first surroundings sensor and the second surroundings sensor should be oriented relative to one another such that the respective detection areas thereof at least partially overlap.

A measurement can in general be interpreted as an observed input, a set of measured values within a particular time interval, or a vector of feature values.

For example, each of the real measurements of the first surroundings sensor at a point in time can be assigned a temporally corresponding real measurement of the second surroundings sensor at the same point in time or at a point in time that is approximately the same.

The first sensor data and the second sensor data may each be unlabeled data, i.e. data that have not been annotated. Likewise, the first simulation data and the second simulation data may be unlabeled data. However, when generating the first simulation data, for example, corresponding labels can be generated automatically, and these labels can then be used to annotate input data, for example the second simulation data, during the generation of the recognition model. As a result, manual creation and/or assignment of labels can be dispensed with.

A learning algorithm can in general be interpreted as an algorithm for the machine learning of a model which converts inputs into specific outputs, for example for the learning of a classification or regression model. The training generation model may, for example, be generated by unsupervised learning. Examples of possible learning algorithms are artificial neural networks, genetic algorithms, support vector machines, k-means, kernel regression or discriminant analysis. The learning algorithm may also comprise a combination of a plurality of the aforementioned examples.

The first simulation data may, for example, have been generated by means of a suitable computation model, which describes physical properties at least of the first surroundings sensor and of surroundings of the vehicle that are to be detected by means of the first surroundings sensor, more specifically of objects in the surroundings of the vehicle that are to be detected by means of the first surroundings sensor (see below). The computation model may also describe physical interactions between the first surroundings sensor and the surroundings of the vehicle.

In accordance with a temporal correlation between the real measurements of the first surroundings sensor and the real measurements of the second surroundings sensor, the simulated measurements of the first surroundings sensor may also be temporally correlated with the simulated measurements of the second surroundings sensor. In other words, the training data generation model may be configured to generate a temporally corresponding simulated measurement of the second surroundings sensor for each simulated measurement of the first surroundings sensor, i.e. to convert each simulated measurement of the first surroundings sensor into a corresponding simulated measurement of the second surroundings sensor.

Training data can be understood to mean data suitable for training, i.e. generating, and/or testing a recognition model. For example, a first subset of the training data may be used to train the recognition model, and a second subset of the training data may be used to test the recognition model after training. Using the training data as test data makes it possible, for example, to perform an evaluation of a recognition model that has already been trained, in order to check the functionality of the trained recognition model and/or calculate quality measures for assessing the recognition performance and/or the reliability of the recognition model.

A method of this kind offers the advantage that synthetic sensor data can be generated by simulation for sensor modalities for which generation models that generate synthetic sensor data of sufficient quality are unavailable or difficult to produce.

For example, the method may be based on the use of an artificial neural network (see below). Specifically, methods for style transfer by means of a generative adversarial network, GAN for short, or by means of “pix2pix” may, for example, be used. (In this regard, see: Goodfellow, Ian, et al. “Generative adversarial nets.” Advances in neural information processing systems. 2014. Isola, Phillip, et al. “Image-to-image translation with conditional adversarial networks.” Proceedings of the IEEE conference on computer vision and pattern recognition. 2017.)

Existing style transfer methods for sensor data generally use different data records for different domains or sensor modalities, wherein the data records do not match, or at least do not match to a sufficient extent, in terms of size and/or content. Thus there are also, in particular, no associations between the domains, which can limit the realism and the achievable accuracy of the results.

The approach described here constitutes an improvement in comparison to the existing methods, in that a further sensor modality is used, and additional information is included in the training by way of the association of the measurements of the various sensor modalities. In this context, the term “association” should be understood to mean that, for the set of all the measured values of the one sensor modality at a particular point in time, there is also an analogous set of measured values of the other sensor modality for the same or approximately the same surroundings at the same or approximately the same point in time, with the result that the learning of the training data generation model, for example by training a GAN, is able to take place using these pairs of sets of measured values of the two sensor modalities. Association of the individual measurements (for example per object) by manually assigning labels can thus be dispensed with, since the association of the sets of measured values that is already provided by the recorded timestamps suffices. When the training data generation model, for example the trained GAN, is applied, it is then possible, for example, for synthetic data of the sensor modality that can readily be simulated to be transformed into the second sensor modality (which is less easy to simulate), wherein, for example, the labels from the simulation can be transferred to the second sensor modality. In this case, a higher degree of accuracy of the transformed sensor data can be achieved owing to the aforementioned associated training data.

A second aspect of the disclosure relates to a computer-implemented method for generating a recognition model for recognizing objects in sensor data from a surroundings sensor system of a vehicle. The method comprises at least the following steps: inputting second simulation data, which have been generated in the method according to an embodiment of the first aspect of the disclosure, as training data into a further learning algorithm; and generating the recognition model based on the training data by means of the further learning algorithm.

For example, at least one classifier, which assigns object classes to measurements of the surroundings sensor system, may be generated as the recognition model based on the training data by the further learning algorithm. The classifier may, for example, output discrete values such as 1 or 0, continuous values or probabilities.

It is also possible for a regression model to be generated as the recognition model based on the training data by the further learning algorithm. For example, the regression model may detect objects and optionally estimate attributes of these detected objects by recognizing measurements of the surroundings sensor system, e.g. by selecting or assigning a subset of measured values from a larger set of measured values.

The method may, for example, be carried out automatically by a processor.

The further learning algorithm may differ from the learning algorithm used to generate the training data generation model. The recognition model may, for example, be generated by supervised learning. The recognition model may, for example, comprise at least one classifier, which has been trained by the further learning algorithm to assign input data, more specifically the sensor data from the surroundings sensor system of the vehicle, to particular classes and/or to recognize objects in the sensor data. A class of this kind may, for example, be an object class, which represents a particular object in the surroundings of the vehicle. Depending on the application, the recognition model may, however, also assign the sensor data to any other types of classes. For example, based on the respective sensor data, the recognition model may output a numerical value that indicates a probability of particular objects occurring in the surroundings of the vehicle or a probability of a particular class as a percentage, or an item of yes/no information such as “1” or “0”.

The recognition model may, for example, also estimate attributes of objects in the surroundings of the vehicle from the sensor data, for example a position and/or location and/or size of the objects, for example by regression.

A third aspect of the disclosure relates to a method for controlling an actuator system of a vehicle. In this case, the vehicle has a surroundings sensor system in addition to the actuator system. The method comprises at least the following steps: receiving sensor data generated by the surroundings sensor system; inputting the sensor data into a recognition model, which has been generated in the method according to an embodiment of the second aspect of the disclosure; and generating a control signal for controlling the actuator system based on outputs from the recognition model.

The method may, for example, be carried out automatically by a processor. The processor may, for example, be a component of a control unit of the vehicle. The actuator system may, for example, comprise a steering actuator, a braking actuator, an engine control unit, an electric motor or a combination of at least two of the aforementioned examples. The vehicle may be equipped with a driver assistance system for semiautomated or fully automated control of the actuator system based on the sensor data from the surroundings sensor system.

A fourth aspect of the disclosure relates to a data processing apparatus. The apparatus comprises a processor, which is configured to carry out the method according to an embodiment of the first aspect of the disclosure and/or the method according to an embodiment of the second aspect of the disclosure and/or the method according to an embodiment of the third aspect of the disclosure. A data processing apparatus can be understood to mean a computer or a computer system. The apparatus may comprise hardware modules and/or software modules. In addition to the processor, the apparatus may comprise a memory, data communication interfaces for data communication with peripheral devices, and a bus system that connects the processor, the memory and the data communication interfaces to one another. Features of the method according to an embodiment of the first, second or third aspect of the disclosure may also be features of the apparatus, and vice versa.

A fifth aspect of the disclosure relates to a computer program. The computer program comprises instructions which, when the computer program is executed by a processor, cause the processor to carry out the method according to an embodiment of the first aspect of the disclosure and/or the method according to an embodiment of the second aspect of the disclosure and/or the method according to an embodiment of the third aspect of the disclosure.

A sixth aspect of the disclosure relates to a computer-readable medium on which the computer program according to an embodiment of the fifth aspect of the disclosure is stored. The computer-readable medium may be a volatile or nonvolatile data memory. For example, the computer-readable medium may be a hard disk, a USB storage device, a RAM, ROM, EPROM or flash memory. The computer-readable medium may also be a data communication network that allows a program code to be downloaded, for example the Internet or a data cloud.

Features of the method according to an embodiment of the first, second or third aspect of the disclosure may also be features of the computer program and/or of the computer-readable medium, and vice versa.

Ideas relating to embodiments of the present disclosure can be considered to be based, inter alia, on the concepts and findings described below.

According to one embodiment, the learning algorithm comprises an artificial neural network. The artificial neural network may comprise an input layer with input neurons and an output layer with output neurons. In addition, the artificial neural network may comprise at least one intermediate layer with hidden neurons, which connects the input layer to the output layer. An artificial neural network of this kind may, for example, be a multilayer perceptron or a convolutional neural network (CNN). An artificial neural network having a plurality of intermediate layers, which is also referred to hereinafter as a deep neural network (DNN), is particularly advantageous. This embodiment makes it possible to generate a training data generation model with a relatively high degree of predictive accuracy.

According to one embodiment, the learning algorithm comprises a generator for generating the second simulation data and a discriminator for evaluating the second simulation data based on the first sensor data and/or the second sensor data. For example, the discriminator may be trained using the first and/or second sensor data and the second simulation data in order to generate the training data generation model. Additionally or alternatively, the generator may be trained using outputs from the discriminator in order to generate the training data generation model. For example, the discriminator may be trained to distinguish outputs from the generator, i.e. the second simulation data, from corresponding real sensor data, while the generator may be trained to generate the second simulation data in such a way that the discriminator recognizes them as real, i.e. is no longer able to distinguish them from the real sensor data. The generator and the discriminator may, for example, be interconnected subnetworks of a generative adversarial network (GAN). A GAN may, for example, be a deep neural network. The fully trained GAN may be able to automatically convert sensor data of one sensor modality, in this case of the first surroundings sensor, into sensor data of another sensor modality, in this case of the second surroundings sensor. This embodiment thus makes it possible to generate the training data generation model in an unsupervised learning process.

According to one embodiment, the method further comprises: generating the first simulation data by means of a computation model, which describes physical properties at least of the first surroundings sensor and of surroundings of the vehicle. The computation model may, for example, comprise a sensor model, which describes the physical properties of the first surroundings sensor, a sensor wave propagation model and/or an object model, which describes physical properties of objects in the surroundings of the vehicle (see below). This embodiment makes it possible to generate any sensor data, in particular sensor data that are difficult to measure.

In general terms, the computation model may be based on describing the physical properties of the first surroundings sensor in a mathematically and algorithmically accurate manner, and on implementing, on this basis, a software module that computationally generates sensor data to be expected from the attributes of the simulated objects, the properties of the respective embodiment of the physical surroundings sensor and the position of the virtual surroundings sensor in the simulation.

Various submodels or corresponding software components may be used to produce the computation model.

The sensor model may be dependent on the sensor modality used, for example lidar, radar or ultrasonic sensor technology. Conversely, the sensor model may be specific to the design of the respective surroundings sensor and optionally to the hardware and/or software version or configuration of the physical surroundings sensor that is actually used. For example, a lidar sensor model may simulate the laser beams emitted by the respective embodiment of the lidar sensor taking into account the specific properties of the physical lidar sensor. These properties may, for example, include the resolution of the lidar sensor in the vertical and/or horizontal direction, the speed or frequency of rotation of the lidar sensor (in the case of a rotating lidar sensor), or the vertical and/or horizontal radiation angle or field of view of the lidar sensor. The sensor model may also simulate the detection of the sensor waves reflected by the objects, which ultimately result in the sensor measurements.

The sensor wave propagation model may also be part of the computation model, e.g. if a lidar sensor is used. Said model describes and calculates the change in the sensor waves on the way from the lidar sensor to a relevant object and on the way back from said object to the lidar sensor. In this case, physical effects such as the attenuation of the sensor waves depending on the distance traveled or the scattering of the sensor waves depending on properties of the surroundings may be taken into account.

Finally, the computation model may additionally comprise at least one object model, which is tasked with calculating changed sensor waves from the sensor waves that reach a respective relevant object. Changes in the sensor waves can occur as a result of some of the sensor waves emitted by the surroundings sensor being reflected by the object. The object model may take into account attributes of the respective object which affect the reflection of the sensor waves. For example, in the case of a lidar sensor, surface properties such as reflectivity may be relevant. The shape of the object, which determines the angle of incidence of the laser, may also be relevant in this case.

The foregoing description of the components of the computation model applies, in particular, to sensor modalities in the case of which sensor waves are actively emitted, as e.g. in the case of lidar, radar or ultrasonic sensors. In the case of passive sensor modalities such as a camera, the computation model may also be divided into the described components. However, the simulation may then differ in part. For example, here, the simulation of the generation of sensor waves can be dispensed with. Instead, a model for generating ambient waves can be used.

For example, the computation model can be used to flexibly create specific traffic situations with a particular, precisely defined behavior by other road users, the movement of the ego vehicle and/or properties of the surroundings of the ego vehicle. In particular in the case of traffic situations that are not well suited to real road tests because they would be too dangerous, simulation with the aid of the computation model is a good way to obtain corresponding data. Moreover, it is almost impossible to recreate all the conceivable and relevant traffic situations in real road tests with a reasonable outlay. The computation model thus makes it possible to simulate rather rare and/or dangerous traffic situations, and thus to generate a representative training sample that is as complete as possible for training the recognition model to behave correctly or for verifying the correct behavior of the recognition model.

According to one embodiment, a target value which should be output by the recognition model is assigned to each of the simulated measurements of the first surroundings sensor by the computation model. The target value may, for example, indicate an object class, such as “pedestrian”, “oncoming vehicle”, “tree” or the like, which is assigned to the respective measurement. The target values, which are also referred to as labels hereinabove and hereinbelow, may, for example, be used, when generating the training data generation model and/or the recognition model, to minimize a loss function that quantifies a deviation between the target values and actual predictions of the training data generation model or recognition model, respectively, e.g. in the context of a gradient method.

According to one embodiment, first simulation data, which have been generated in the method according to an embodiment of the first aspect of the disclosure, are furthermore input as the training data into the further learning algorithm. In this case, a first classifier, which assigns object classes to measurements of a first surroundings sensor of the surroundings sensor system, is generated as the recognition model based on the first simulation data by the further learning algorithm. Additionally or alternatively, in this case, a second classifier, which assigns object classes to measurements of a second surroundings sensor of the surroundings sensor system, is generated as the recognition model based on the second simulation data by the further learning algorithm. This embodiment makes it possible to use simulation data to train the recognition model to recognize objects in sensor data of two different sensor modalities. The inputting of labeled real sensor data into the further learning algorithm can be dispensed with in this case. Thus, laborious manual annotation of the training data can be dispensed with, resulting in savings in terms of time and costs.

Additionally or alternatively, for example, a first regression model, which detects objects in measurements of a first surroundings sensor of the surroundings sensor system and/or estimates object attributes, for example attributes of the objects detected in the measurements of the first surroundings sensor, may be generated as the recognition model based on the first simulation data by the further learning algorithm.

Additionally or alternatively, for example, a second regression model, which detects objects in measurements of a second surroundings sensor of the surroundings sensor system and/or estimates object attributes, for example attributes of the objects detected in the measurements of the second surroundings sensor, may be generated as the recognition model based on the second simulation data by the further learning algorithm.

According to one embodiment, target values, which have been assigned in the method according to an embodiment of the second aspect of the disclosure, are furthermore input into the further learning algorithm. In this case, the recognition model is furthermore generated based on the target values by the further learning algorithm. As a result of this embodiment, manual annotation of the training data can be dispensed with.

### BRIEF DESCRIPTION OF THE DRAWINGS

Embodiments of the disclosure will be described below with reference to the appended drawings, wherein neither the drawings nor the description should be interpreted as limiting the disclosure.

FIGS. 1a and 1b schematically show a data processing apparatus according to one exemplary embodiment of the disclosure.

FIG. 2 shows a flowchart for illustrating a method for generating training data according to one exemplary embodiment of the disclosure.

FIG. 3 shows a flowchart for illustrating a method for generating a recognition model according to one exemplary embodiment of the disclosure.

FIG. 4 shows a flowchart for illustrating a method for controlling a vehicle according to one exemplary embodiment of the disclosure.

The figures are merely schematic rather than to scale. Identical reference signs in the figures designate identical features or features having the same effect.

### DETAILED DESCRIPTION

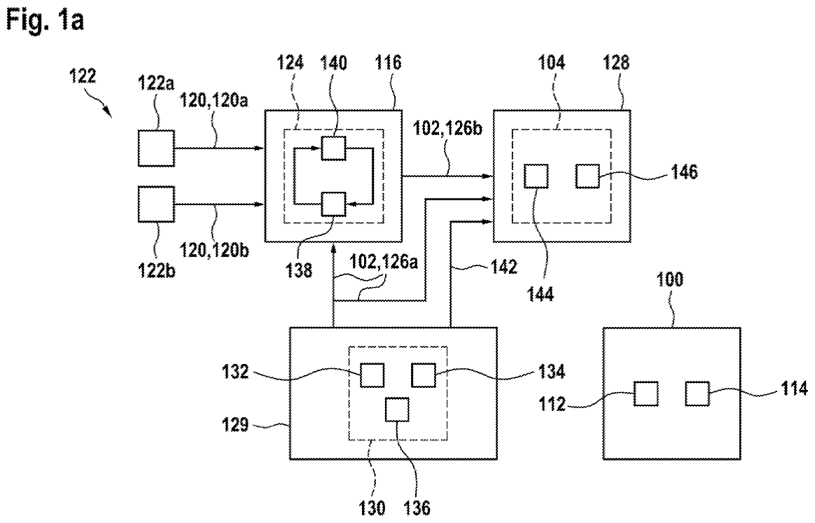

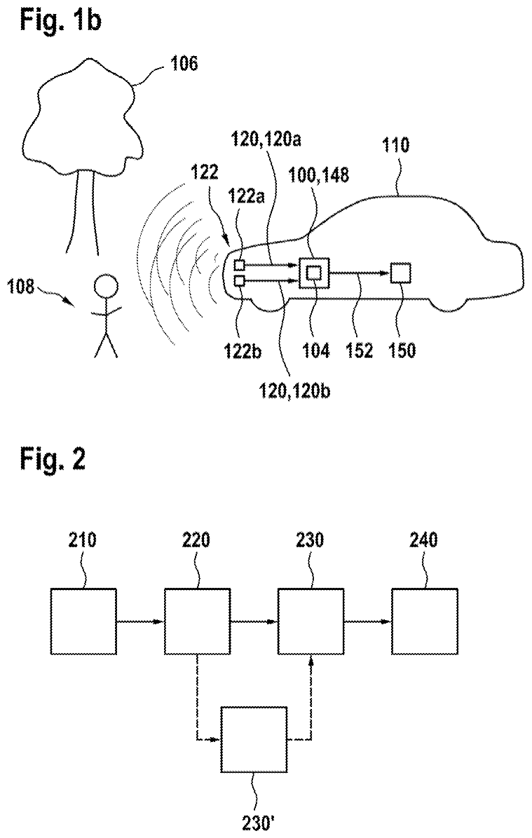

FIG. 1a shows an apparatus 100 for generating training data 102 and for generating a recognition model 104 for recognizing objects 106, 108 in the surroundings of a vehicle 110 (see FIG. 1b) based on the training data 102. The apparatus 100 comprises a processor 112 for executing a corresponding computer program and a memory 114 on which the computer program is stored. The modules of the apparatus 100 that are described hereinbelow may be software modules and be executed by execution of the computer program by the processor 112. However, it is also possible for the modules described hereinbelow to be additionally or alternatively implemented as hardware modules.

The method steps described hereinbelow are illustrated in flowcharts in FIG. 2 to FIG. 4.

In order to generate the training data 102, the apparatus 100 comprises a training data generation module 116, which executes a suitable learning algorithm.

In step 210 (see FIG. 2), sensor data 120, which have been generated by a surroundings sensor system 122 of the vehicle 110, are input into the learning algorithm. The sensor data 120 comprise first sensor data 120a, which have been generated by a first surroundings sensor 122a of the surroundings sensor system 122, for example a camera or a lidar sensor, and second sensor data 120b, which have been generated by a second surroundings sensor 122b of the surroundings sensor system 122, for example a radar or ultrasonic sensor. The two surroundings sensors 122a, 122b may thus constitute two different sensor modalities A and B, respectively. The surroundings sensors 122a, 122b may be oriented relative to one another such that the respective detection areas thereof at least partially overlap. The first sensor data 120a comprise a plurality of chronologically successive real measurements of the first surroundings sensor 122a, for example a plurality of chronologically successive individual images generated by the camera or of chronologically successive point clouds generated by the lidar sensor. Similarly, the second sensor data 120b comprise a plurality of chronologically successive real measurements of the second surroundings sensor 122b, for example a plurality of chronologically successive echo distances generated by the radar or ultrasonic sensor. Exactly one temporally corresponding measurement of the second surroundings sensor 122b is assigned to each measurement of the first surroundings sensor 122a, i.e. the measurements of the two surroundings sensors 122a, 122b are linked to one another in pairs in relation to time, wherein each pair is assigned to one and the same time step or timestamp. The term “measurement” here should be understood to mean a set of measured values or individual measurements that is generated by the respective surroundings sensor 122a or 122b within a specific period of time, i.e. a frame.

In step 220, the learning algorithm executed by the training data generation module 116 generates a training data generation model 124 from the first sensor data 120a and the second sensor data 120b, said training data generation model assigning measurements of the second surroundings sensor 122b to measurements of the first surroundings sensor 122a. More specifically, the training data generation model 124 generates the measurements of the second surroundings sensor 122b, which are assigned to measurements of the first surroundings sensor 122a. For this purpose, the learning algorithm may, for example, train an artificial neural network, as described in more detail below.

The sensor data 120 that are used to generate the training data generation model 124 may originate from one and the same vehicle 110 or else from a plurality of vehicles 110.

Subsequently, in step 230, first simulation data 126a are input into the training data generation model 124. Similarly to the first sensor data 120a, the first simulation data 126a comprise a plurality of chronologically successive simulated measurements of the first surroundings sensor 122a, with the difference that in this case the measurements are measurements of the virtual, and not of the physical, first surroundings sensor 122a.

In step 240, the training data generation model 124 then generates corresponding second simulation data 126b as the training data 102 and outputs said data to a training module 128 for the generation of the recognition model 104. Similarly to the first simulation data 126a, the second simulation data 126b or the training data 102 comprise a plurality of chronologically successive simulated measurements of the second surroundings sensor 122b, which are temporally correlated with the simulated measurements of the first surroundings sensor 122a.

For example, the first simulation data 126a may be generated by a simulation module 129, on which a suitable physical computation model 130 runs, in a step 230′ that precedes the step 230. Depending on the sensor modality to be simulated, the computation model 130 may, for example, comprise a sensor model 132 for simulating the first surroundings sensor 122a, an object model 134 for simulating the objects 106, 108 and/or a sensor wave propagation model 136, as has been described above.

The learning algorithm executed by the training data generation module 116 may, for example, be configured to generate an artificial neural network in the form of a generative adversarial network, GAN for short, as the training data generation model 124. A GAN of this kind may comprise a generator 138 for generating the second simulation data 126b and a discriminator 140 for evaluating the second simulation data 126b. For example, in step 220, the discriminator 140 may be trained, using the sensor data 120, to distinguish between measured sensor data, i.e. real measurements of the surroundings sensor system 122, and computer-calculated simulation data, i.e. simulated measurements of the surroundings sensor system 122, wherein the generator 138 may be trained, using outputs from the discriminator 140, such as “1” for “simulated” and “0” for “real”, to generate the second simulation data 126b in such a way that the discriminator 140 is no longer able to distinguish them from the real sensor data, i.e. recognizes them as real. The training data generation model 124 may thus be generated by unsupervised learning, i.e. without the use of labeled input data.

In addition, in step 230′, the simulation module 129 may generate a target value 142 for each of the simulated measurements of the first surroundings sensor 122a, said target value indicating a desired output of the recognition model 104 to be generated. The target value 142, which is also known as a label, may, for example, indicate an object class, in this case, for example, “tree” and “pedestrian”, or another suitable class. The target value 142 may, for example, be a numerical value assigned to the (object) class.

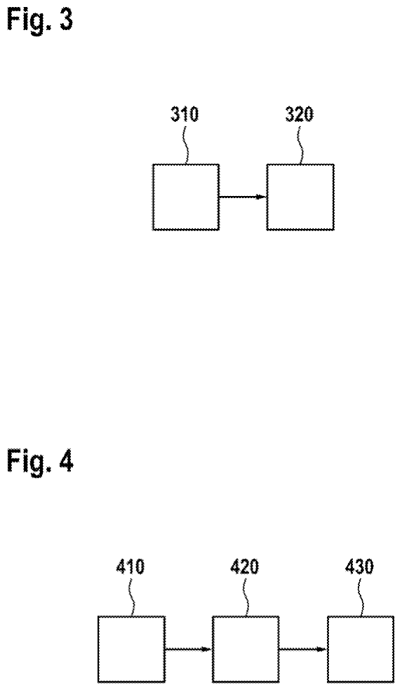

In step 310 (see FIG. 3), the training module 128 receives the training data 102 from the training data generation module 116 and inputs said data into a further learning algorithm.

In step 320, the further learning algorithm, which may, for example, be a further artificial neural network, uses machine learning to generate the recognition model 104 for recognizing the objects 106, 108 in the surroundings of the vehicle 110 as a “tree” or “pedestrian” from the training data 102. In this case, at least one classifier 144, 146 may be trained to assign the training data 102 to corresponding object classes, here, for example, to the object classes “tree” and “pedestrian”.

The training data 102 may comprise the first simulation data 126a and/or the second simulation data 126b. For example, the further learning algorithm may use the first simulation data 126a to train a first classifier 144 for classifying the first sensor data 120a, said first classifier being assigned to the first surroundings sensor 122a, and/or use the second simulation data 126b to train a second classifier 146 for classifying the second sensor data 120b, said second classifier being assigned to the second surroundings sensor 122b. However, it is also possible for the further learning algorithm to train more than two classifiers or just a single classifier. Additionally or alternatively to the classifier, the further learning algorithm may, for example, train at least one regression model.

The generation of the recognition model 104 in step 320 may be carried out using the target values 142 or labels 142 generated by the simulation module 129.

The recognition model 104 generated in this way may then, for example, be implemented as a software and/or hardware module in a control unit 148 of the vehicle 110 and be used to automatically control an actuator system 150 of the vehicle 110, for example a steering or braking actuator or a drive motor of the vehicle 110. For example, the vehicle 110 may be equipped with a suitable driver assistance function for this purpose. However, the vehicle 110 may also be an autonomous robot with a suitable control program.

The sensor data 120 provided by the surroundings sensor system 122 are received in the control unit 148 in step 410 (see FIG. 4) in order to control the actuator system 150.

In step 420, the sensor data 120 are input into the recognition model 104, which is executed by a processor of the control unit 148 in the form of a corresponding computer program.

In step 430, depending on the output from the recognition model 104, for example depending on the recognized object 106 or 108 and/or depending on the recognized speed, position and/or location of the recognized object 106 or 108, the control unit 148 finally generates a corresponding control signal 152 for controlling the actuator system 150 and outputs said control signal to the actuator system 150. The control signal 152 may, for example, cause the actuator system 150 to control the vehicle 110 in such a way that a collision with the recognized object 106 or 108 is avoided.

Various exemplary embodiments of the disclosure will be described once again hereinbelow in other words.

For example, the generation of the training data 102 may comprise the following phases.

In a first phase, there is obtained and recorded a multimodal, unlabeled sample of real sensor data 120 with associated measurements, i.e. the sample consists of pairs of sets of measurements of both sensor modalities A and B, i.e. of both surroundings sensors 122a and 122b, for each point in time.

In a second phase, an artificial neural network, e.g. a GAN, is trained using the unlabeled sample obtained in the first phase.

In a third phase, a labeled sample is generated by simulation and transformation using the artificial neural network trained in the second phase.

The generation of the multimodal, unlabeled sample of real sensor data 120 in the first phase may, for example, take place as follows.

A single vehicle 110 or a fleet of vehicles 110 may be used for this purpose. The vehicle 110 may be equipped with two or more surroundings sensors 122a, 122b of two different sensor modalities A and B. For example, the sensor modality A may be a lidar sensor system and the sensor modality B may be a radar sensor system. The sensor modality A should be a surroundings sensor for which sensor data can be generated by simulation with the aid of the computation model 130, wherein these simulation data should have a high quality insofar as they match the real sensor data of the sensor modality A to a good approximation. The two surroundings sensors 122a, 122b should be provided and attached to the vehicle 110 and oriented such that there is a significant region of overlap of the respective fields of view thereof. A multimodal, unlabeled sample is created using the vehicle 110 equipped in this way or the vehicles 110 equipped in this way.

In this case, it should be possible to assign the totality of all the measurements of the sensor modality A at a particular point in time to the totality of all the measurements of the sensor modality B at the same point in time, or at least at a point in time that is approximately the same. For example, the surroundings sensors 122a, 122b may be synchronized with one another such that the measurements of both surroundings sensors 122a, 122b are taken in each case at the same point in time. In this context, “assignment” or “association” should therefore not be understood to mean that measurements of the sensor modality A with respect to a particular static or dynamic object are associated with measurements of the sensor modality B with respect to the same object. This would require a corresponding (manual) annotation of the sample, which is precisely what the method described here is intended to avoid.

For example, the multimodal, unlabeled sample may be recorded on a persistent memory in the vehicle 110 and then transferred to an apparatus 100 suitable for the second phase. Alternatively, the sample may be transferred while the vehicle is actually traveling, e.g. via a mobile radio network or the like.

The generation of the training data generation model 124 by training the GAN in the second phase may, for example, take place as follows.

As has already been mentioned, the multimodal sample obtained and recorded in the first phase may be used in the second phase to train an artificial neural network in the form of a GAN. The GAN may be trained so that it is able, after completion of the training, to transform measurements of the sensor modality A that can readily be simulated into measurements of the sensor modality B which is less easy to simulate.

The training may take place using pairs of associated sets of measurements of the two sensor modalities A and B. In this context, a set of measurements should be understood to mean all the measurements of the respective sensor modality A or B at a particular point in time or within a short period of time. A set of measurements of this kind may typically contain sensor data for a plurality of static and dynamic objects and may, for example, also be referred to as a frame. A frame may, for example, be an individual image of a camera or a point cloud of a single lidar sweep.

The set of measurements of the sensor modality A at a particular point in time t(n) may be used as input for the GAN, while the set of measurements of the sensor modality B at the same point in time t(n) may constitute a desired output for the associated input. The time t is not absolutely necessary for the training. The weights of the training data generation model 124 may then be determined by iterative training of the GAN, which may be a deep neural network (DNN). After completion of the training, the GAN is able to generate, for a frame of the sensor modality A that is not included in the training set, a corresponding frame of the sensor modality B.

The generation of a simulated, labeled sample in the third phase may, for example, take place as follows.

A labeled sample of the sensor modality B may now be generated by simulation in the third phase by using the GAN trained in the second phase, even if there is no suitable physical computation model available for the sensor modality B.

Initially, the first simulation data 126a of the sensor modality A are generated. This takes place with the aid of the simulation module 129, which may, for example, simulate both the movement of the vehicle 110 and the movement of other objects 106, 108 in the surroundings of the vehicle 110. In addition, the static surroundings of the vehicle 110 may be simulated, with the result that static and dynamic surroundings of the vehicle 110 are generated at each point in time, wherein the object attributes can be selected in a suitable manner, and relevant labels 142 for the objects 106, 108 can thus be derived. The synthetic sensor data for these objects 106, 108 in the form of the first simulation data 126a are generated by the computation model 130 in this case.

The respectively assigned labels 142, which are referred to hereinabove as target values 142, i.e. the attributes of the simulated dynamic and static objects, are thus also available as ground truth for the first simulation data 126a of the sensor modality A. Said labels may also be output by the simulation module 129. The first simulation data 126a without the labels 142 are then transformed by the training data generation model 124 in the form of the trained GAN model into sensor data of the sensor modality B, i.e. into the second simulation data 126b, which represent the same, simulated surroundings of the vehicle 110 at each point in time. For this reason, the labels 142 generated by the simulation module 129 also apply to the second simulation data 126b. For example, the assignment of sensor data of the sensor modality A to sensor data of the sensor modality B can take place such that the labels 142, which describe the surroundings of the vehicle 110 at a particular point in time, can be transferred directly without any change, e.g. without prior interpolation.

Depending on the application, a resulting labeled sample consisting of the second simulation data 126b and the labels 142 or target values 142, or else a resulting labeled multimodal sample consisting of the first simulation data 126a, the second simulation data 126b and the labels 142 or target values 142 can be used as the training data 102 for generating the recognition model 104, e.g. for training a deep neural network.

Alternatively or additionally, the training data 102 can be used to optimize and/or validate surroundings perception algorithms, e.g. in that a replay of the unlabeled sample is carried out, and a comparison of the symbolic surroundings representation generated by the algorithms, i.e. of the attributes of the objects of the surroundings that are generated by pattern recognition algorithms, with the ground truth attributes of the labeled sample is carried out.

Finally, it should be noted that terms such as “having”, “comprising”, etc. do not exclude other elements or steps, and terms such as “a” or “an” do not exclude a plurality.

What is claimed is:

1. A method for generating training data for a recognition model configured to recognize objects in sensor data from a surroundings sensor system of a vehicle, the method comprising:
inputting first sensor data and second sensor data into a learning algorithm, the first sensor data including a plurality of chronologically successive real measurements of a first surroundings sensor of the surroundings sensor system, the second sensor data including a plurality of chronologically successive real measurements of a second surroundings sensor of the surroundings sensor system, each real measurement in the plurality of chronologically successive real measurements of the second surroundings sensor being assigned to a temporally corresponding real measurement in the plurality of chronologically successive real measurements of the first surroundings sensor;
generating a training data generation model configured to generate measurements of the second surroundings sensor assigned to measurements of the first surroundings sensor based on the first sensor data and the second sensor data using the learning algorithm;
inputting first simulation data into the training data generation model, the first simulation data including a plurality of chronologically successive simulated measurements of the first surroundings sensor; and
generating second simulation data as the training data based on the first simulation data using of the training data generation model, the second simulation data including a plurality of chronologically successive simulated measurements of the second surroundings sensor.

2. The method according to claim 1, wherein the learning algorithm includes an artificial neural network.

3. The method according to claim 1, wherein the learning algorithm includes a generator configured to generate the second simulation data and a discriminator configured to evaluate the second simulation data based on at least one of (i) the first sensor data and (ii) the second sensor data.

4. The method according to claim 1 further comprising:
generating the first simulation data using a computation model that describes physical properties of the first surroundings sensor and of surroundings of the vehicle.

5. The method according to claim 4, wherein the computation model is configured to assign a target value to be output by the recognition model to each of the simulated measurements in the plurality of chronologically successive simulated measurements of the first surroundings sensor.

6. The method according to claim 1 further comprising:
generating the recognition model by:
inputting the second simulation data as training data into a further learning algorithm; and
generating the recognition model based on the training data using the further learning algorithm.

7. The method according to claim 6, the generating the recognition model further comprising:
inputting the first simulation data as training data into the further learning algorithm, the first simulation data having been generated using a computation model that describes physical properties of the first surroundings sensor and of surroundings of the vehicle; and
at least one of:
generating, based on the first simulation data using the further learning algorithm, as the recognition model a first classifier configured to assign object classes to measurements of the first surroundings sensor; and
generating, based on the second simulation data using the further learning algorithm, as the recognition model a second classifier configured to assign object classes to measurements of the second surroundings sensor.

8. The method according to claim 7, the generating the recognition model further comprising:
inputting, into the further learning algorithm, target values to be output by the recognition model, the target values having been assigned by the computation model to each of the simulated measurements in the plurality of chronologically successive simulated measurements of the first surroundings sensor; and
generating the recognition model further based on the target values using the further learning algorithm.

9. The method according to claim 6 further comprising:
controlling an actuator system of the vehicle by:
receiving further sensor data generated by the surroundings sensor system;
inputting the further sensor data into the recognition model; and
generating a control signal configured to control the actuator system based on outputs from the recognition model.

10. A data processing apparatus for generating training data for a recognition model configured to recognize objects in sensor data from a surroundings sensor system of a vehicle, the data processing apparatus comprising:
a processor configured to:
input first sensor data and second sensor data into a learning algorithm, the first sensor data including a plurality of chronologically successive real measurements of a first surroundings sensor of the surroundings sensor system, the second sensor data including a plurality of chronologically successive real measurements of a second surroundings sensor of the surroundings sensor system, each real measurement in the plurality of chronologically successive real measurements of the second surroundings sensor being assigned to a temporally corresponding real measurement in the plurality of chronologically successive real measurements of the first surroundings sensor;
generate a training data generation model configured to generate measurements of the second surroundings sensor assigned to measurements of the first surroundings sensor based on the first sensor data and the second sensor data using the learning algorithm;
input first simulation data into the training data generation model, the first simulation data including a plurality of chronologically successive simulated measurements of the first surroundings sensor; and
generate second simulation data as the training data based on the first simulation data using of the training data generation model, the second simulation data including a plurality of chronologically successive simulated measurements of the second surroundings sensor.

11. The method according to claim 1, wherein the method is performed by a processor that exectutes instructions of a computer program.

12. A non-transitory computer-readable medium that stores a computer program for generating training data for a recognition model configured to recognize objects in sensor data from a surroundings sensor system of a vehicle, the computer program including instructions that, when executed by a processor, cause the processor to:
input first sensor data and second sensor data into a learning algorithm, the first sensor data including a plurality of chronologically successive real measurements of a first surroundings sensor of the surroundings sensor system, the second sensor data including a plurality of chronologically successive real measurements of a second surroundings sensor of the surroundings sensor system, each real measurement in the plurality of chronologically successive real measurements of the second surroundings sensor being assigned to a temporally corresponding real measurement in the plurality of chronologically successive real measurements of the first surroundings sensor;
generate a training data generation model configured to generate measurements of the second surroundings sensor assigned to measurements of the first surroundings sensor based on the first sensor data and the second sensor data using the learning algorithm;
input first simulation data into the training data generation model, the first simulation data including a plurality of chronologically successive simulated measurements of the first surroundings sensor; and
generate second simulation data as the training data based on the first simulation data using of the training data generation model, the second simulation data including a plurality of chronologically successive simulated measurements of the second surroundings sensor.
